(19) United States
(12) Patent Application Publication
(10) Pub. No.: US 2025/0251615 A1
(43) Pub. Date: Aug. 7, 2025

(54) ADJUSTMENT MECHANISM AND LENS MODULE

(71) Applicant: AAC Microtech (Changzhou) Co., Ltd., Changzhou (CN)

(72) Inventors: Xingzhi Huang, Changzhou (CN); Wei Song, Changzhou (CN); Zhang Ren, Changzhou (CN); Jie Ma, Changzhou (CN)

(21) Appl. No.: 18/741,811

(22) Filed: Jun. 13, 2024

Related U.S. Application Data
(63) Continuation of application No. PCT/CN2024/076046, filed on Feb. 5, 2024.

(51) Int. Cl. G02B 27/64; G03B 5/00

(52) U.S. Cl. CPC G02B 27/646; G03B 5/00; G03B 2205/0007; G03B 2205/0069

(57) ABSTRACT

The present application provides an adjustment mechanism and a lens module. The adjustment mechanism includes an anti-shake assembly. The anti-shake assembly includes an anti-shake circuit board and a flexible sheet cooperatively connected to the anti-shake circuit board, and the flexible sheet includes a first main body and a first folded edge arranged circumferentially around the first main body. The first folded edge is arranged perpendicularly to a plane of the first main body. The anti-shake circuit board includes a second main body, and a second folded edge arranged circumferentially around the second main body. The production cost of the adjustment mechanism of the present application is lower and has better control accuracy, and the application of the adjustment mechanism to the lens module reduces the overall production cost of the lens module and ensures that the lens module has better control and adjustment accuracy.

### CROSS-REFERENCE TO RELATED APPLICATIONS

The present application is a continuation of International Application No. PCT/CN2024/076046, filed Feb. 5, 2024, the entire contents of which are incorporated herein by reference.

### TECHNICAL FIELD

The present application relates to the technical field of optical imaging, in particular to an adjustment mechanism and a lens module.

### BACKGROUND

The camera module in the related art assists users in obtaining clear images through an anti-shake mechanism. The physical driving methods for camera modules generally include spring-type, ball-type, and memory alloy-type mechanisms. The lens module includes an adjustment mechanism, which includes an anti-shake circuit board and a flexible connection plate. In the related art, the active edges of the anti-shake circuit board are generally formed by stacking multi-layer boards, and the active edges of the flexible connecting plate are formed using an etching process, which makes the overall production cost of the lens module higher and the overall structural rigidity poor, which in turn makes the overall stability of the lens module poor, and thus reduces the adjustment accuracy of the lens module.

Therefore, it is necessary to provide an adjustment mechanism and a lens module with low production cost and better adjustment accuracy.

### SUMMARY

An object of the present application is to provide an adjustment mechanism and a lens module. The adjustment mechanism has lower production costs and better control accuracy, and the adjustment mechanism applied to the lens module reduces the overall production cost of the lens module and ensures that the lens module has better control and adjustment accuracy.

The technical solution of the present application is as follows.

In a first aspect, the present application provides an adjustment mechanism, comprising:
an anti-shake assembly comprising:
   an anti-shake circuit board comprising
      a second main body;
      a second folded edge arranged circumferentially around the second main body; and
      an electrical connection portion connected to a side of the second folded edge; and
a flexible sheet cooperatively connected to the anti-shake circuit board, and comprising:
   a first main body; and
   a first folded edge arranged circumferentially around the first main body, and arranged perpendicularly to a plane of the first main body.

In one embodiment, the first folded edge and the second folded edge are all connected in a corresponding region; or, the first folded edge and the second folded edge are connected by a plurality of fitting structures spaced apart; and the fitting structures are uniformly distributed along the corresponding region of the first folded edge and the second folded edge.

In one embodiment, the first main body and the second main body are coaxially provided; the flexible sheet as a whole is centrally symmetrically at a center of the first main body, or the flexible sheet as a whole is axially symmetrically along one of a x-direction or a y-direction.

In one embodiment, the flexible sheet further comprises a first connecting block, the first connecting block being symmetrically arranged on both sides of the first main body and connected to the first folded edge; the anti-shake circuit board further comprises a second connecting block, the second connecting block being symmetrically arranged on both sides of the second main body and connected to the second folded edge; and the first connecting block and the second connecting block are arranged correspondingly.

In one embodiment, the first connecting block comprises a first connecting portion connected to the first main body and second connecting portions connected to the first folded edge; the second connecting portions are symmetrically arranged on both sides of the first connecting portion, and separate the first folded edge to form a first segment and a second segment; the first segment and the second segment are spaced apart to form a first notch; the second connecting block is connected to the second folded edge and separates the second folded edge to form a third segment and a fourth segment, and the third segment and the fourth segment are spaced apart to form a second notch; the first notch and the second notch are provided in correspondence, and the first segment and the third segment are provided in correspondence.

In one embodiment, the anti-shake assembly further comprises an anti-shake bracket and a base plate; the anti-shake bracket is arranged in a region enclosed by the anti-shake circuit board, and the flexible sheet is supported on the base plate; a spacer is arranged between the base plate and the flexible sheet, the first folded edge is connected to the spacer, and the second folded edge is connected to the anti-shake bracket.

In one embodiment, the anti-shake bracket comprises a connecting ring provided in a square shape, a first connecting arm provided in a corner region of the connecting ring, and second connecting arms symmetrically provided on both sides of the connecting ring; wherein the second connecting arm is arranged through the first notch and the second notch, and the second connecting arm is provided with connecting lugs connected to an inner wall of the second folded edge.

In one embodiment, the electrical connection portion is provided on an outer side of the second folded edge and provided parallel to the second main body; the electrical connection portion is provided on the third segment, and a region of the first segment corresponding to the electrical connection portion is provided with a third notch; an end of the third notch is extended outwardly to form third folded edges provided parallel to the first main body, the third folded edges are connected to each other through a first connecting piece, and the electrical connection portion is connected to an upside of the first connecting piece.

In one embodiment, the second segment is provided with a fourth notch arranged symmetrically to the third notch, a fourth folded edge and a second connecting piece arranged symmetrically to the third folded edge and the first connecting piece, respectively; wherein the fourth segment is provided with a fifth folded edge extending outwardly in a region corresponding to the electrical connection portion and provided parallel to the second main body; the fifth folded edge is connected to an upside of the second connecting piece, and the spacer is connected to a downside of the first connecting piece and a bottom side of the second connecting piece.

In one embodiment, the anti-shake assembly further comprises anti-shake coils, anti-shake magnetic steels, and a casing; the anti-shake coils are arranged between the first connecting arm and the second connecting arm and arranged circumferentially around the connecting ring, and the anti-shake magnetic steels are arranged above the anti-shake coils correspondingly; the casing and the base plate together form an accommodating space for accommodating the flexible sheet, the anti-shake circuit board, the anti-shake bracket, the anti-shake coils, and the anti-shake magnetic steels.

In a second aspect, the present application provides a lens module, comprising an adjustment mechanism as described above and an image-sensing assembly.

The beneficial effect of the present application is as follows.

The first folded edge and the second folded edge of the adjustment mechanism of the present application are arranged vertically relative to a plane of the first main body and a plane of the second main body, respectively. The first folded edge and the second folded edge are arranged in a three-dimensional folding structure, thereby saving the etching process, simplifying the process of preparing parts, improving assembly efficiency, and reducing production costs. Besides, the folded edge structure of the flexible sheet and the folded edge structure of the anti-shake circuit board are arranged to meet the rigidity requirements in the x-direction, y-direction, and y-direction of the anti-shake circuit board and ensure that the stable support of the z-axis while guaranteeing the anti-shake stability in the x- and y-directions.

### BRIEF DESCRIPTION OF THE DRAWINGS

FIG. 1 shows a structural schematic diagram of an anti-shake assembly of the present application.

FIG. 2 shows an exploded view of the anti-shake assembly of the present application.

FIG. 3 shows a cross-sectional view of the anti-shake assembly of the present application.

FIG. 4 shows a structural schematic diagram of a flexible sheet.

FIG. 5 shows a structural schematic diagram of an anti-shake circuit board.

FIG. 6 shows a schematic diagram of an internal structure of the anti-shake assembly.

FIG. 7 is a schematic diagram of a connection structure between an anti-shake bracket and the anti-shake circuit board.

In the figures, 100, anti-shake assembly; 1, anti-shake circuit board; 11, second main body; 12, second folded edge; 121, third segment; 122, fourth segment; 123, second notch; 13, electrical connection portion; 14, second connecting block; 2, flexible sheet; 21, first main body; 22, first folded edge; 221, first segment; 222, second segment; 223, first notch; 224, third notch; 225, third folded edge; 226, first connecting piece; 227, fourth notch; 228, fourth folded edge; 229, second connecting piece; 23, first connecting block; 231, first connecting portion; 232, second connecting portion; 3, anti-shake bracket; 31, connecting ring; 32, first connecting arm; 33, second connecting arm; 331, connecting lug; 4, base plate; 5, spacer; 6, anti-shake coil; 7, anti-shake magnetic steel; 8, casing; and 200, image-sensing assembly.

### DETAILED DESCRIPTION OF THE EMBODIMENTS

The present application is further described below with reference to the accompanying drawings and embodiments.

In order to facilitate understanding of the present application, the application will be described more fully below with reference to the relevant accompanying drawings. The preferred embodiments of the present application are given in the accompanying drawings. However, the present application may be realized in many different forms and is not limited to the embodiments described herein. Rather, these embodiments are provided to enable a more thorough and comprehensive understanding of the disclosure of the present application.

When an element is considered to be “connected” to another element, it may be directly connected to the other element or there may be both centered elements. In this application, descriptions such as “first”, “second”, “third”, “fourth” in the present application are for descriptive purposes only, and are not to be construed as indicating or implying their relative importance or implicitly specifying the number of technical features indicated.

In the description of the present application, the terms “top”, “bottom”, “top”, “inside”, “outside” and the like indicate orientations or positional relationships based on those shown in the accompanying drawings, and are only intended to facilitate the description of the present application and to simplify the description, and are not intended to indicate or imply that the device or element referred to must have a specific orientation, be constructed and operated with a specific orientation, and therefore are not to be construed as a limitation of the present application.

### Embodiment One

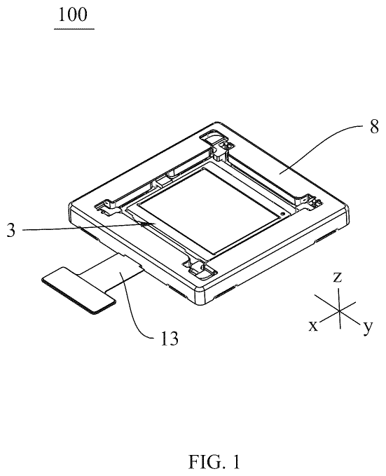

As shown in FIGS. 1 to 3, the present application discloses an adjustment mechanism including an anti-shake assembly 100. The anti-shake assembly 100 includes an anti-shake circuit board 1 and a flexible sheet 2 cooperatively connected to the anti-shake circuit board 1. The flexible sheet 2 includes a first main body 21 and a first folded edge 22 arranged circumferentially around the first main body 21, and arranged perpendicularly to a plane of the first main body 21. The anti-shake circuit board 1 includes a second main body 11, a second folded edge 12 arranged circumferentially along the second main body 11, and an electrical connection portion 13 connected to a side of the second folded edge 12. In an embodiment, the flexible sheet 2 is a metal spring sheet.

The first folded edge 22 and the second folded edge 12 are arranged vertically relative to a plane of the first main body 1 and a plane of the second main body 2, respectively. The first folded edge and the second folded edge are arranged in a three-dimensional folding structure, so that the anti-shake circuit board 1 and the flexible sheet 2 can be molded in a single pass during the part preparation process, thereby saving the etching process, simplifying the process of preparing parts, improving the assembly efficiency, and reducing the production cost. Besides, the folded edge structure of the flexible sheet 2 and the folded edge structure of the anti-shake circuit board 1 are arranged to meet the rigidity requirements in the x-direction, y-direction, and y-direction of the anti-shake circuit board and ensure that the stable support of the z-axis while guaranteeing the anti-shake stability in the x- and y-directions.

In this embodiment, the x-direction, y-direction, and z-direction are spatially perpendicular to each other, and the z-direction is parallel to the direction of an optical axis of the camera module.

The first folded edge 22 and the second folded edge 12 are all connected in a corresponding region, or the first folded edge 22 and the second folded edge 12 are connected by a plurality of fitting structures spaced apart, and the fitting structures are uniformly distributed along the corresponding regions of the first folded edge 22 and the second folded edge 12 to ensure the uniformity of the overall stiffness of the connecting structure of the anti-shake circuit board and the flexible sheet.

The first main body 21 and the second main body 11 are coaxially arranged. The flexible sheet 2 as a whole is centrally symmetrically at the center of the first main body 21, or the flexible sheet 2 as a whole is axially symmetrically along one of the x-direction or the y-direction. Specifically, in some embodiments, the first main body 21 and the second main body 11 are coaxially arranged. The flexible sheet 2 as a whole is centrally symmetrically at the center of the first main body 21 or the center of the second main body 11. In other embodiments, the first main body 21 and the second main body 11 are coaxially arranged, and the electrical connection portion 13 is arranged in the x-direction. The anti-shake circuit board 1 is axisymmetrically arranged in the x-direction, and the flexible sheet 2 as a whole is axisymmetrically arranged in the x-direction. In other embodiments, the first main body 21 and the second main body 11 are coaxially arranged, and the electrical connection portion 13 is arranged in the x-direction. The anti-shake circuit board 1 is arranged axially symmetrically along the x-direction, and the flexible sheet 2 as a whole is arranged symmetrically along the y-direction. The flexible sheet 2 is matched with the shape of the anti-shake circuit board 1, which ensures the rigidity of the whole structure, further ensuring the stability of the overall stability of the anti-shake mechanism as well as the stability of the anti-shake adjusting function.

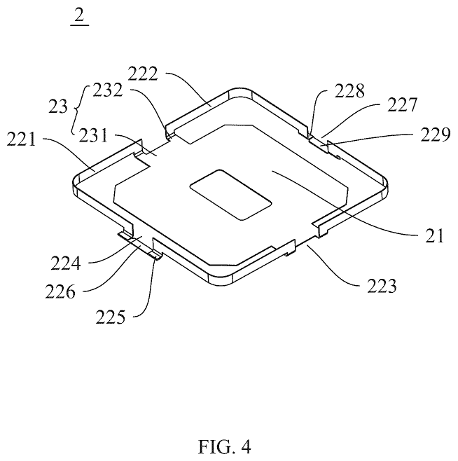

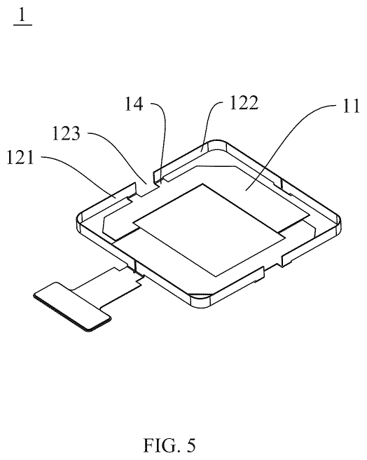

As shown in FIGS. 4 and 5, the flexible sheet 2 further includes a first connecting block 23. The first connecting block 23 is symmetrically arranged on both sides of the first main body 21 and connected to the first folded edge 22. The anti-shake circuit board 1 further includes a second connecting block 14. The second connecting block 14 is symmetrically arranged on both sides of the second main body 11 and connected to the second folded edge 12. The first connecting block 23 and the second connecting block 14 are provided correspondingly. In embodiments of the present application, the electrical connection portion 13 is provided in the y-direction.

In some embodiments, the first connecting block 23 includes a first connecting portion 231 connected to the first main body 21 and second connecting portions 232 connected to the first folded edge 22. The second connecting portions 232 are symmetrically arranged on both sides of the first connecting portion 231, and separate the first folded edge 22 to form a first segment 221 and a second segment 222. The first segment 221 and the second segment 222 are spaced apart to form a first notch 223. The second connecting block 14 is connected to the second folded edge 12 and separates the second folded edge 12 to form a third segment 121 and a fourth segment 122, and the third segment 121 and the fourth segment 122 are spaced apart to form a second notch 123. The first notch 223 and the second notch 123 are provided in correspondence, and the first segment 221 and the third segment 121 are provided in correspondence. In the structural setting of the first connecting block 23, the width of the first connecting section 231 is greater than the width of the second connecting section 232, which ensures that there is a larger connecting region between the first connecting section 231 and the first main body 21, and in turn ensures the strength of the connection between the first connecting block 23 and the first main body 21, thereby avoiding damage to the connection area between the first connecting block 23 and the first main body 21 in the course of long-term use, and ensuring the durability of the flexible sheet 2.

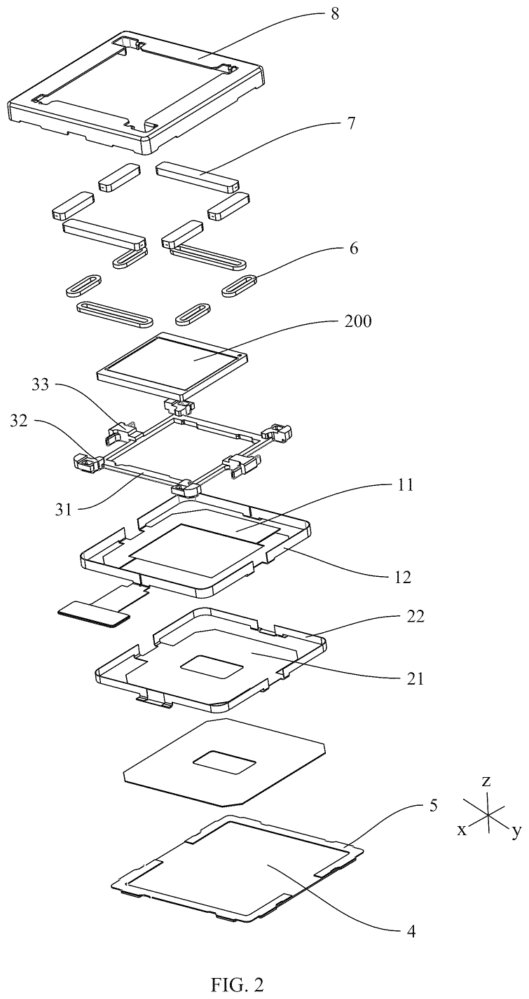

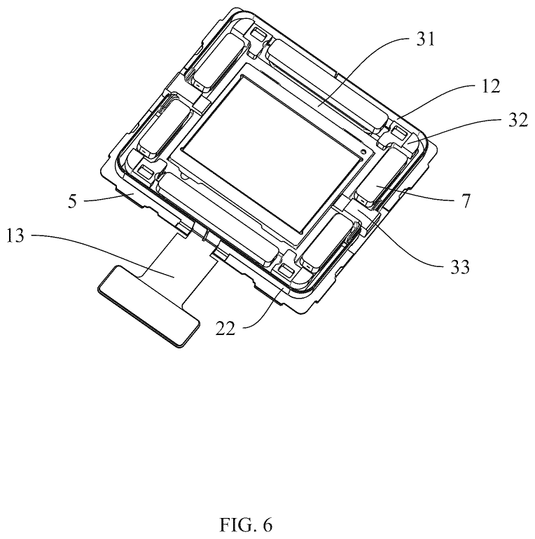

As shown in FIGS. 2 and 6, the anti-shake assembly 100 further includes an anti-shake bracket 3 and a base plate 4. The anti-shake bracket 3 is arranged in a region enclosed by the anti-shake circuit board 1, and the flexible sheet 2 is supported on the base plate 4. A spacer 5 is arranged between the base plate 4 and the flexible sheet 2, the first folded edge 22 is connected to the spacer 5, and the second folded edge 12 is connected to the anti-shake bracket 3. In some embodiments, the spacers 5 are provided in correspondence with an edge region of the base plate 4, and the spacers 5 include a first spacer and a second spacer symmetrically provided along the y-direction.

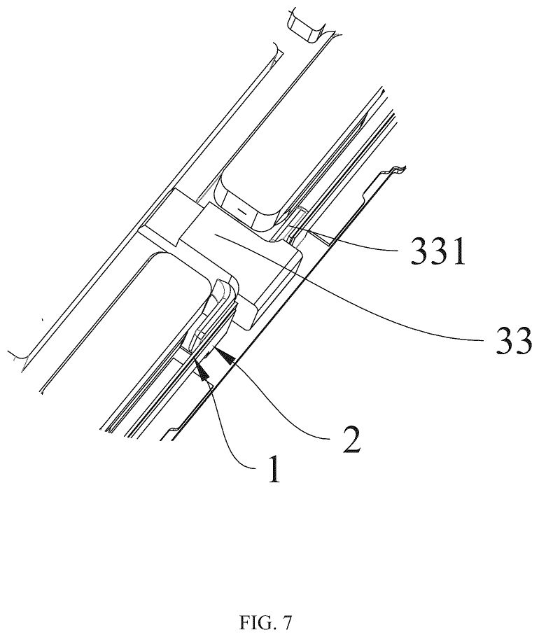

As shown in FIGS. 6 and 7, the anti-shake bracket 3 includes a connecting ring 31 provided in a square shape, a first connecting arm 32 provided in a corner region of the connecting ring 31, and second connecting arms 33 symmetrically provided on both sides of the connecting ring 31. The second connecting arms 33 are arranged through the first notch 223 and the second notch 123, and the second connecting arm 33 is provided with connecting lugs 331 connected to the inner wall of the second folded edge 12.

As shown in FIGS. 2 to 6, the electrical connection portion 13 is provided on the outer side of the second folded edge 12 and provided parallel to the second main body 11. The electrical connection portion 13 is provided on the third segment 121, and a region of the first segment 221 corresponding to the electrical connection portion 13 is provided with a third notch 224. An end of the third notch 224 is extended outwardly to form third folded edges 21 provided parallel to the first main body 21, the third folded edges 225 are connected to each other through a first connecting piece 226, and the electrical connection portion 13 is connected the upside of the first connecting piece 226. It is to be noted that the outward direction refers to a direction away from the center axis of the first main body 21.

Further, the second segment 222 is provided with a fourth notch 227 arranged symmetrically to the third notch 224, and a fourth folded edge 228 and a second connecting piece 229 arranged symmetrically to the third folded edge 225 and the first connecting piece 226, respectively. The fourth segment 122 is provided with a fifth folded edge outwardly extending in a region corresponding to the electrically connecting part 13 and arranged in parallel with the second main body 11. The fifth folded edge is connected to the upside of the second connecting piece 229, and the spacer 5 is connected to the bottom side of first connecting piece 226 and the bottom side of the second connecting piece 229, in order to provide a fixed connection to the flexible piece, and thus to provide a fixed support to the connecting structure between the flexible piece and the anti-shake circuit board. That is, a stable support in the z-direction of the anti-shake assembly 100 is ensured. The upside refers to a direction away from the base plate 4 and the bottom side refers to a direction close to the base plate 4.

As shown in FIGS. 1 and 2, the anti-shake assembly 100 further includes anti-shake coils 6, anti-shake magnetic steels 7, and a casing 8. The anti-shake coils 6 are arranged between the first connecting arm 32 and the second connecting arm 33 arranged circumferentially around the connecting ring 31, and the anti-shake magnetic steels 7 are arranged above the anti-shake coils 6 correspondingly. The casing 8 and the bottom plate 4 together form an accommodating space for accommodating the flexible sheet 2, the anti-shake circuit board 1, the anti-shake bracket 3, the anti-shake coils 6, and the anti-shake magnetic steels 7. Specifically, the anti-shake coils 6 are attached to the second main body 11, and the anti-shake magnetic steels 7 are connected to the casing 8.

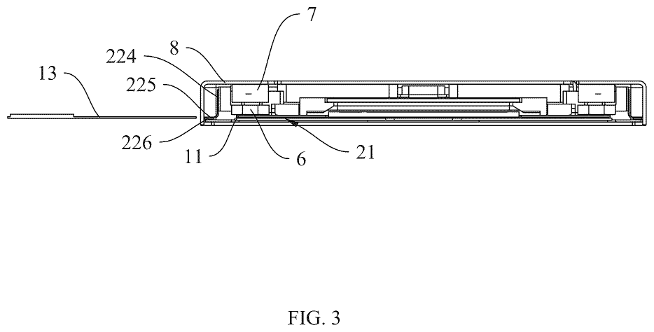

Embodiments of the present application further disclose a lens module including an adjustment mechanism as described above and an image-sensing assembly 200. As shown in FIG. 3, the image-sensing assembly 200 is arranged in a region surrounded by the anti-shake circuit board 1 and the anti-shake bracket 3, and the image-sensing assembly 200 is arranged on the second main body 11. When the anti-shake is adjusted, the anti-shake assembly 100 drives the image-sensing assembly 200 to move to supplement the amount of displacement due to shaking so as to obtain a clear image.

A center region of the first main body 21 is provided with a first hole, and a center region of the second main body 11 is provided with a second hole. The image sensing assembly 200 is provided in correspondence with the second hole, and the first hole is configured to dissipate heat from the image-sensing assembly. In an embodiment, the first hole and the second hole are coaxially provided, and the cross-sectional area of the first hole is smaller than the cross-sectional area of the second hole. A third hole is provided in a region of the top of the casing 8 corresponding to the anti-shake bracket 3.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. An adjustment mechanism, comprising:
an anti-shake assembly comprising:
an anti-shake circuit board comprising
a second main body;
a second folded edge arranged circumferentially around the second main body; and
an electrical connection portion connected to a side of the second folded edge; and
a flexible sheet cooperatively connected to the anti-shake circuit board, and comprising:
a first main body; and
a first folded edge arranged circumferentially around the first main body, and arranged perpendicularly to a plane of the first main body.

2. The adjustment mechanism of claim 1, wherein the first folded edge and the second folded edge are all connected in a corresponding region; or, the first folded edge and the second folded edge are connected by a plurality of fitting structures spaced apart; and the fitting structures are uniformly distributed along the corresponding region of the first folded edge and the second folded edge.

3. The adjustment mechanism of claim 1, wherein the first main body and the second main body are coaxially provided; the flexible sheet as a whole is centrally symmetrically at a center of the first main body, or the flexible sheet as a whole is axially symmetrically along one of a x-direction or a y-direction.

4. The adjustment mechanism of claim 3, wherein the flexible sheet further comprises a first connecting block, the first connecting block being symmetrically arranged on both sides of the first main body and connected to the first folded edge; the anti-shake circuit board further comprises a second connecting block, the second connecting block being symmetrically arranged on both sides of the second main body and connected to the second folded edge; and the first connecting block and the second connecting block are arranged correspondingly.

5. The adjustment mechanism of claim 4, wherein the first connecting block comprises a first connecting portion connected to the first main body and second connecting portions connected to the first folded edge; the second connecting portions are symmetrically arranged on both sides of the first connecting portion, and separate the first folded edge to form a first segment and a second segment; the first segment and the second segment are spaced apart to form a first notch; the second connecting block is connected to the second folded edge and separate the second folded edge to form a third segment and a fourth segment, and the third segment and the fourth segment are spaced apart to form a second notch; the first notch and the second notch are provided in correspondence, and the first segment and the third segment are provided in correspondence.

6. The adjustment mechanism of claim 5, wherein the anti-shake assembly further comprises an anti-shake bracket and a base plate; the anti-shake bracket is arranged in a region enclosed by the anti-shake circuit board, and the flexible sheet is supported on the base plate; a spacer is arranged between the base plate and the flexible sheet, the first folded edge is connected to the spacer, and the second folded edge is connected to the anti-shake bracket.

7. The adjustment mechanism of claim 6, wherein the anti-shake bracket comprises a connecting ring provided in a square shape, a first connecting arm provided in a corner region of the connecting ring, and second connecting arms symmetrically provided on both sides of the connecting ring; wherein the second connecting arm is arranged through the first notch and the second notch, and the second connecting arm is provided with connecting lugs connected to an inner wall of the second folded edge.

8. The adjustment mechanism of claim 6, wherein the electrical connection portion is provided on an outer side of the second folded edge and provided parallel to the second main body; the electrical connection portion is provided on the third segment, and a region of the first segment corresponding to the electrical connection portion is provided with a third notch; an end of the third notch is extended outwardly to form third folded edges provided parallel to the first main body, the third folded edges are connected to each other through a first connecting piece, and the electrical connection portion is connected to an upside of the first connecting piece.

9. The adjustment mechanism of claim 8, wherein the second segment is provided with a fourth notch arranged symmetrically to the third notch, a fourth folded edge and a second connecting piece arranged symmetrically to the third folded edge and the first connecting piece, respectively; wherein the fourth segment is provided with a fifth folded edge extending outwardly in a region corresponding to the electrical connection portion and provided parallel to the second main body; the fifth folded edge is connected to an upside of the second connecting piece, and the spacer is connected to a downside of the first connecting piece and a bottom side of the second connecting piece.

10. The adjustment mechanism of claim 6, wherein the anti-shake assembly further comprises anti-shake coils, anti-shake magnetic steels, and a casing; the anti-shake coils are arranged between the first connecting arm and the second connecting arm and arranged circumferentially around the connecting ring, and the anti-shake magnetic steels are arranged above the anti-shake coils correspondingly; the casing and the base plate together form an accommodating space for accommodating the flexible sheet, the anti-shake circuit board, the anti-shake bracket, the anti-shake coils, and the anti-shake magnetic steels.

11. A lens module, comprising:
an adjustment mechanism of claim 1; and
an image-sensing assembly.
